(19) United States
(12) Patent Application Publication
(10) Pub. No.: US 2014/0291988 A1
(43) Pub. Date: Oct. 2, 2014

(54) Electric Generator

(71) Applicant: Ezio Bertotto, Bolzano Vicentino (VI) (IT)

(72) Inventor: Ezio Bertotto, Bolzano Vicentino (VI) (IT)

(73) Assignee: REEL S.R.L., Ponte di Nanto (VI) (IT)

(21) Appl. No.: 14/000,796

(22) PCT Filed: Feb. 21, 2012
(86) PCT No.: PCT/IB2012/050776

§ 371 Date: Oct. 8, 2013

(30) Foreign Application Priority Data
Feb. 23, 2011 (IT) VI2011U000013

(51) Int. Cl. F03D 9/00

(52) U.S. Cl. CPC F03D 9/003
USPC 290/44

(57) ABSTRACT

An electric generator (1) for the conversion of energy from a renewable energy source, such as wind energy, into electrical energy to be inserted into a local or remote network (R), which comprises a rotary electric machine (2) provided with means (3) for drawing energy from the renewable source and for converting into electrical energy, first control means (4) for regulating the functioning parameters of the machine (2), second control means (5) for regulating the parameters of the electrical energy generated by the machine (2), and connection means (6) for electrically connecting the second control means (5) to the network (R), wherein the machine (2) is positioned in a space (V) placed at a predetermined distance (h) with respect to a base (B) that is fixed or anchorable with respect to the ground (T). The first control means (4) are housed in a first case (7) placed inside the space (V), the second control means (5) are housed in a second case (8) that is different and spatially offset with respect of the first, and the second control means (5) are electrically connected to the first control means (4), to facilitate the mounting and the maintenance of the generator.

### FIELD OF APPLICATION

The present invention generally find application in the technical field of electric machines and in particular relates an electric generator for converting kinetic energy coming from a renewable energy source, e.g. wind, into electrical energy injectable into the local or remote distribution network.

### STATE OF THE ART

As is known, the known electric generators essentially comprise a rotary electric machine for converting the energy drawn from a renewable energy source, e.g. of wind, hydraulic or geothermal type, into electrical energy to be inserted in a local or remote distribution network.

The generator is also provided with control means for controlling the electrical functioning parameters of the electric machine and the parameters associated with the generated electricity in a manner so as to allow the insertion thereof in the network.

FIG. 1 schematically illustrates a wind plant E which comprises an electric generator G of known type with a rotary machine A connected directly or via a mechanical multiplier (not shown in the figure) to the wind turbine B and electrically connected to control means M through electrical connection means L.

The control means M comprise one or more inverters I and one or more converters C, of known type, generally housed inside a single case P. The converters C are generally connected to an electrical distribution board D in turn connected to the distribution and/or local electrical network R by means of suitable electric wires S.

Should the generator G have a power greater than several kilowatts, the control means M must be capable of regulating electrical parameters with relatively high nominal values. In this case, the heat generated via Joule effect by the control means M, in particular by the inverters I and by the converters C is considerable and must be eliminated by means of suitable heat dissipaters or exchangers associated with the electric circuits of the inverters I or of the converters C.

One drawback of such known solution is represented by the fact that the electric circuits of the inverters I and the converters C have electronic power devices with complex wiring, which considerably increases the overall size and bulk of the control means M.

A further drawback is represented by the fact that the heat dissipaters and/or exchangers associated with the control means M have considerable size and weight, which makes their positioning in particular types of installations quite difficult, e.g. in the nacelles of wind generators.

A further drawback is represented by the fact that the bulk of the control means M is such to require the use of connection means L of considerable length, such to generate electromagnetic emissions of undesired frequency during the functioning of the generator G.

A further drawback is represented by the fact that, particularly in average-power and high-power plants, the control means M are housed in spaces that are very hard for operators assigned the maintenance thereof to reach.

### PRESENTATION OF THE INVENTION

A main object of the present invention is to overcome the abovementioned drawbacks by providing an electric generator which has high efficiency and relatively low cost characteristics.

A further particular object of the invention is to provide an electric generator which allows reducing the bulk and the weight of the control means, even for specific user-requested configurations.

A particular object of the invention is to provide an electric generator which has electronic control means that can be easily accessed during maintenance operations.

A further object of the invention is to provide a generator which allows reducing the length of the electrical connections with the rotary machine, in a manner so as to reduce the undesired electromagnetic emissions. A further particular object of the invention is to provide an electric generator which allows reducing the weight and the bulk of the cooling means.

These objects, as well as others which will be clearer below, are attained by an electrical energy generator, in accordance with claim 1, which comprises a rotary electric machine provided with means for drawing kinetic energy from the renewable source, first control means for regulating the functioning parameters of said machine, second control means for regulating the parameters of the generated electrical energy, and means for the electrical connection of said second control means to the network, wherein said machine is positioned in a space situated at a predetermined distance with respect to a base that is fixed or anchorable with respect to the ground.

The generator is characterized in that the first control means are housed in a first case placed inside said space, said second control means being housed in a second case that is different and spatially distant from the first, and said second means being electrically connected to said first control means, in a manner so as to facilitate the mounting and the maintenance of the generator.

Due to this particular configuration, the electric generator has reduced weight and bulk and is easily accessible by a user, especially during maintenance operations.

The dependent claims illustrate advantageous embodiments of the invention.

### BRIEF DESCRIPTION OF THE DRAWINGS

Further characteristics and advantages of the invention will be clearer in light of the detailed description of a preferred but not exclusive embodiment of an electric generator, illustrated as a non-limiting example with the aid of the drawing table set, in which:

FIG. 1 is a schematic view of a generator of the state of the art;

FIG. 2 is a schematic view of a first embodiment of the generator according to the invention;

FIG. 3 is a schematic view of a second embodiment of the generator according to the invention.

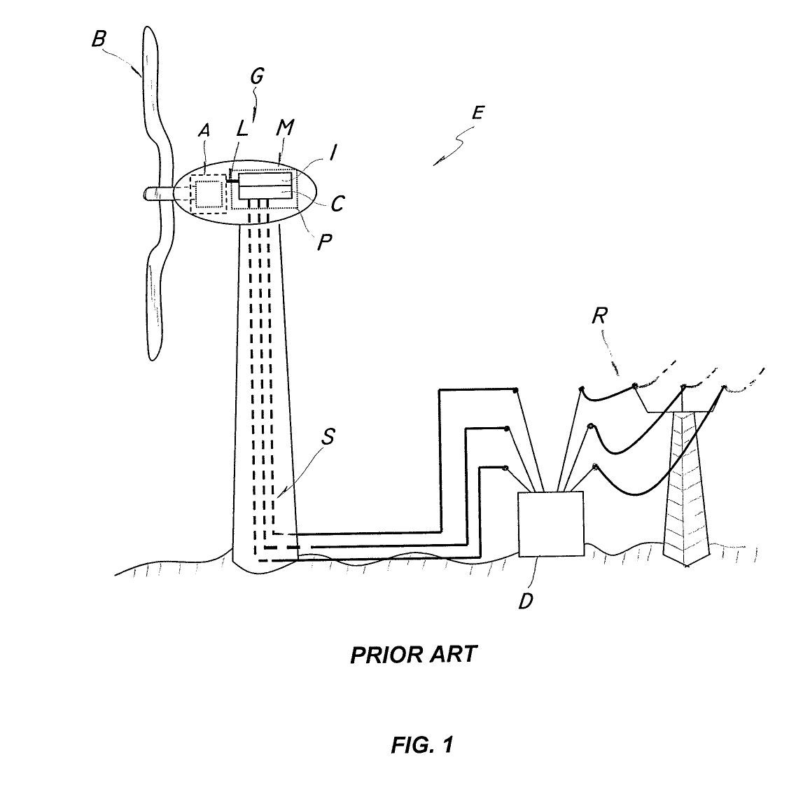

### DETAILED DESCRIPTION OF A PREFERRED EMBODIMENT

With reference to the mentioned figures, the electric generator according to the invention, generally indicated with the reference number 1, can be used for the production of electrical energy starting from renewable energy sources, such as wind, hydroelectric, geothermal or the like.

The electrical energy produced by the generator 1 can be inserted in a local or remote distribution electrical network R.

The electric generator 1 according to the invention essentially comprises a rotary machine 2 provided with means 3 for drawing energy from the renewable source in order to generate electrical energy; such machine 2 is positioned in a space V placed at a distance from a base B that is fixed or anchorable to the ground T.

The generator 1 comprises first control means 4 for regulating the functioning parameters of the rotary machine 2 and second control means 5 for regulating the functioning parameters of the electrical energy generated by the same machine.

In addition, the generator 1 comprises first connection means 6 for the electrical connection of the second control means 5 to the electrical network R.

According to a particular characteristic of the invention, the first control means 4 are housed in a first case 7 placed inside the space V, close to the rotary machine 2.

The second control means 5 are instead housed in a second case 8 that is different and spatially distant from the first case 7, such means 5 electrically connected to the first control means 4 in a manner so as to facilitate the mounting and the maintenance of the generator 1.

The first 7 and the second 8 cases can have different size in order to be adapted to the size of the first 4 and the second 5 control means, respectively.

Suitably, the cases 7, 8 will be electrically insulated from the respective control means 4, 5 in a manner so as to result electrically neutral.

The first control means 4 can be electrically connected to the second control means 5 by means of second electrical connection means 9, such as electric wires, bars or similar conductors.

Possibly, the first case 7 can be placed directly in contact with metal surfaces 10 present inside the space V without making any type of electric contact.

Advantageously, as illustrated in the figures, the generator 1 can be of wind type with a space V placed inside a nacelle N anchored to a tower W.

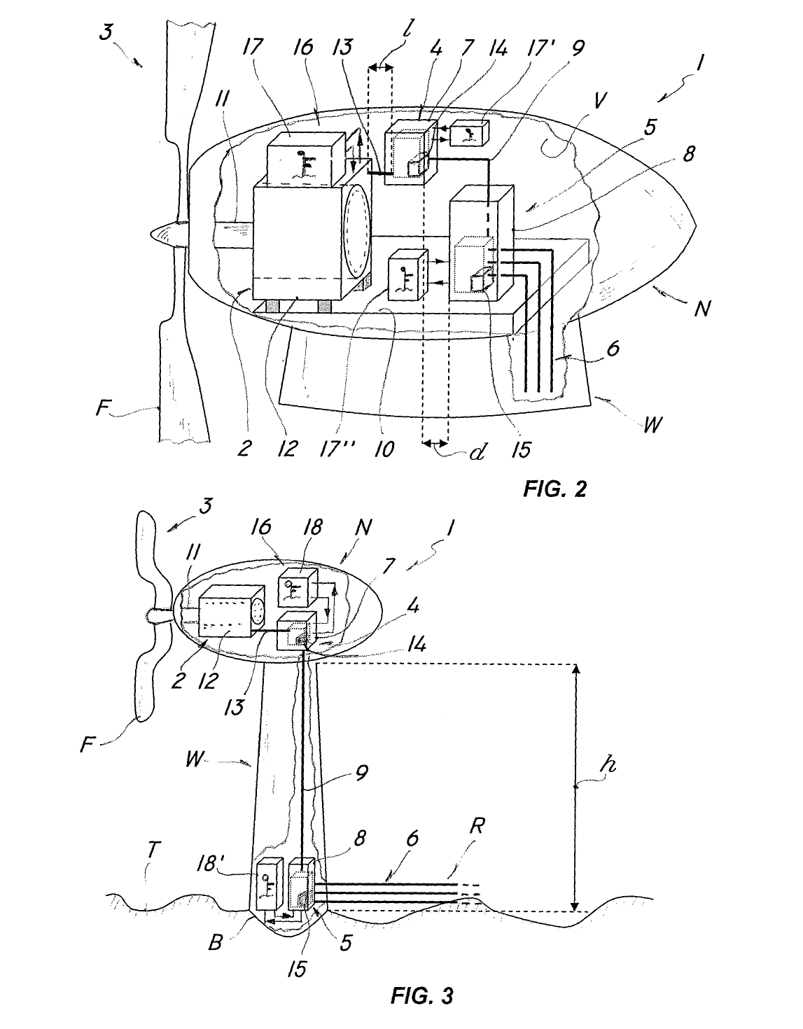

In the first embodiment illustrated in FIG. 2, the energy drawing means 3 constituted by a wind turbine F are fixed on a power shaft 11 in turn mechanically connected, directly or by means of a reducer/multiplier, to the rotary machine 2.

The rotary machine 2 is housed inside the space V of the nacelle N. Also the second case 8 can be housed inside the space V, at a distance d from the first case 7.

Advantageously, the distance d will be determined in a manner so as to optimize the overall distribution of the weight of the generator 1 in the space V.

In addition, the position of the second case 8 can be determined in a manner so as to facilitate the passage of the first electrical connection means 6.

In the second embodiment illustrated in FIG. 3, the second case 8 can be placed outside the space V, e.g. in the tower W close to the base B, in a position that is easily accessible by an operator.

In addition, the second connection means 9 can be placed inside the tower W.

Possibly, regardless of the positioning of the second control means 5, the rotary machine 2 can be housed inside a third case 12 placed almost directly in contact with the first case 7 in a manner so as to reduce the electrical connections 13 between the rotary machine 2 and the first control means 4.

According to the configuration illustrated in FIG. 2 and FIG. 3, the length I of the electrical connections 13 between the electrical machine 2 and the first control means 4 can be selected in a manner such to reduce the emission of electromagnetic waves, i.e. limit the undesired emission, with value lower than a pre-established limit.

The first control means 4 can comprise at least one inverter 14 and the second control means 5 can comprise at least one converter 15.

As is clearly visible in FIG. 3, only the inverters 14 can be positioned in the space V of the nacelle N, while the converters 15 can be housed at the base B of the support tower W.

This configuration will be particularly advantageous in the case of a generator 1 placed inside a space V with reduced size and/or intended to support generators 1 with limited weight.

Suitably, the inverter 14 can be configured for regulating the electrical parameters associated with the rotary electric machine 2.

In addition, as illustrated in the figures, the rotary machine 2, the first control means 4 and the second control means 5 can comprise cooling means 16 for eliminating the heat generated during functioning.

In the case of a generator 1 of limit electric power, the quantity of heat to be eliminated will not be particularly high; there can be air cooling means 16 of laminated or similar type, not illustrated in the figures.

In the case of a generator 1 of relatively high power, e.g. greater than 5 kW, the cooling means 16 can comprise one or more heat exchangers, not illustrated in the figures, with cooling circuits crossed by one or more cooling fluids.

In an alternative configuration, not illustrated in the figures, the cooling means 16 can comprise a cooling circuit common to the rotary machine 2, the first control means 4 and the second control means 5.

This in order to reduce the bulk and weight of the cooling means 16, e.g. if the generator 1 must be positioned in a space V of particularly small size.

In the embodiment illustrated in FIG. 2, each cooling means 16 of the generator components, i.e. rotary machine 2, the first 4 and the second 5 control means, can comprise a respective heat exchange circuit 17, 17′, 17″ crossed by respective refrigerant fluids.

In the embodiment illustrated in FIG. 3, the cooling means 16 comprise a first cooling circuit 18 common to the rotary machine 2 and to the first control means 4 and a second heat exchange circuit 18′ for the second control means 5.

In such embodiment, the first common heat exchange circuit 18 reduces the bulk of the generator 1 portion placed inside the space V, and at the same time the second exchange circuit 18′ can be housed close to the second control means 5.

For the sake of completeness, it is observed that the rotary machine 2 can be of magnetic reluctance type, in a manner so as to have energy yields greater than the generators comprising rotary machines 2 of known type.

The generator according to the invention is susceptible to numerous modifications and variants, all falling within the inventive concept expressed in the enclosed claims. All details can be substituted by technically equivalent elements, and the materials can be different as required, without departing from the scope of the invention.

Even if the generator has been described with particular reference to the enclosed figures, the reference numbers used in the description and in the claims are used for improving the comprehension of the invention, and do not constitute any limitation of the claimed protective scope.

The invention claimed is:

1. An electric generator (1) for the conversion of energy from a renewable energy source, such as wind energy, into electrical energy to be inserted into a local or remote network (R), which generator comprising:
a rotary machine (2) provided with means (3) for drawing energy from the renewable source and converting into electrical energy:
first control means (4) for adjusting the operative parameters of said rotary machine (2);
second control means (5) for adjusting the parameters of the electrical energy generated by said rotary machine (2); and
connection means (6) for electrically connecting said second control means (5) to the network (R);
wherein said rotary machine (2) is positioned in a space (V) placed at a predetermined distance (h) with respect to a base (B) that is fixed or anchorable to a ground (T); and
wherein said first control means (4) are housed in a first case (7) placed inside said space (V), said second control means (5) being housed in a second case (8) that is different and spatially offset with respect of the first case, said second control means (5) being electrically connected to said first control means (4) to facilitate mounting and the-maintenance of the electric generator.

2. The generator according to claim 1, wherein said second case (8) is placed inside said space (V).

3. The generator according to claim 1, wherein said second case (8) is placed outside said space (V), close to said base (B).

4. The generator according to claim 1, wherein said rotary machine (2) is housed inside a third case (12) placed directly into contact with said first case (7) to reduce the length of the electrical connections (13) between said machine (2) and said first control means (4).

5. The generator according to claim 1, wherein said first control means (4) comprise at least one inverter (14) and said second control means (5) comprise at least one converter (15).

6. The generator according to claim 1, wherein said rotary machine (2), said first control means (4) and said second control means (5) comprise cooling means (16) for eliminating the heat generated during operation.

7. The generator according to claim 6, wherein said cooling means (16) comprise a cooling circuit common to said rotary machine (2), said first control means (4) and said second control means (5).

8. The generator according to claim 6, wherein each of said rotary machine (2), first control means (4) and second control means (5) comprise different cooling circuits (17, 17′, 17″).

9. The generator according to claim 6, wherein said cooling means (16) comprise a first cooling circuit (18) common to said rotary machine (2) and to said first control means (4) and a second heat exchange circuit (18′) for said second control means (5).

10. The generator according to claim 1, wherein said generator is a wind generator, said space (V) being constituted by a nacelle (N) anchored to a support tower (W).

11. The generator according to claim 1, wherein said rotary machine (2) is of magnetic reluctance type.

12. The generator according to claim 1, wherein said rotary machine (2) comprises permanent magnets.
